(19) United States
(12) Patent Application Publication
(10) Pub. No.: US 2015/0149896 A1
(43) Pub. Date: May 28, 2015

(54) RECIPIENT-BASED PREDICTIVE TEXTING

(71) Applicant: Arun Radhakrishnan, Zapopan (MX)

(72) Inventor: Arun Radhakrishnan, Zapopan (MX)

(21) Appl. No.: 14/092,361

(22) Filed: Nov. 27, 2013

(51) Int. Cl. G06F 17/24

(52) U.S. Cl. CPC G06F 17/24
USPC 715/271

(57) ABSTRACT

Technologies for predictive texting on a communication device includes determining an identity of a recipient of a textual communication and determining a suggested textual phrase based on a user selected textual character and the identity of the recipient. The suggested textual phrase may be embodied as a single word or a collection of words. The communication device may store a recipient-based predictive text dictionary that correlates user selected textual characters to suggested textual phrases based on the identity of the recipient. In this way, the suggested textual phrase for a particular character or collection of characters may change based on the identity of the recipient.

### BACKGROUND

Personal communication devices are quickly becoming ubiquitous personal tools, even replacing traditional land-based communication devices such as the telephone. Personal communication devices allow users to quickly and efficiently communicate with each other, regardless of the user's location, using one of a number of different communication modalities, such as texting, e-mail, and/or social networking. Many personal communication devices are designed with a small form factor to increase the portability of such devices. Due to their relative miniature size, the personal communication devices may similarly include miniature keyboards or virtual keyboards for data entry. When using a textual-based communication modality, such as texting or e-mail, the miniature or virtual keyboards can be difficult to operate, often resulting in typographical errors or unintended word choice.

Predictive texting is often implemented in personal communication devices to reduce the time, complexity, and typographical errors associated with textual-based communications on a personal communication device. Predicative texting is a technology in which predicted or suggested words are presented to the user of the personal communication device in response to selection of a textual character or string of characters. As the user continues to select textual characters, such as characters of a word, the predicted or suggested word or words are updated in accordance with the textual characters entered or selected by the user. If the predicted word is the particular word desired by the user, the user may simply select the predicted word to cause the selected predicted word to be included in the textual communication without the need to fully type out the word. In this way, predictive texting can decrease the time spent creating a textual message, as well as the likelihood of typographical errors. Predictive texting may rely on a predictive text dictionary, which is typically based on the user's historical word or phrase usage and, in some cases, the current context of the textual message.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for recipient-based predictive texting;

FIG. 2 is a simplified block diagram of at least one embodiment of an environment of a communication device of the system of FIG. 1;

FIG. 3 is a simplified data structure of at least one embodiment of a recipient-based predictive text dictionary;

FIGS. 4 and 5 is a simplified flow diagram of at least one embodiment of a method for predictive texting based on an identity of a recipient;

FIG. 6 is a simplified illustration of at least one embodiment of a user interface of the communication device of FIG. 1 during execution of the method of FIGS. 4 and 5; and

FIG. 7 is a simplified illustration of at least one additional embodiment of the user interface of the communication device of FIG. 1 during execution of the method of FIGS. 4 and 5.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

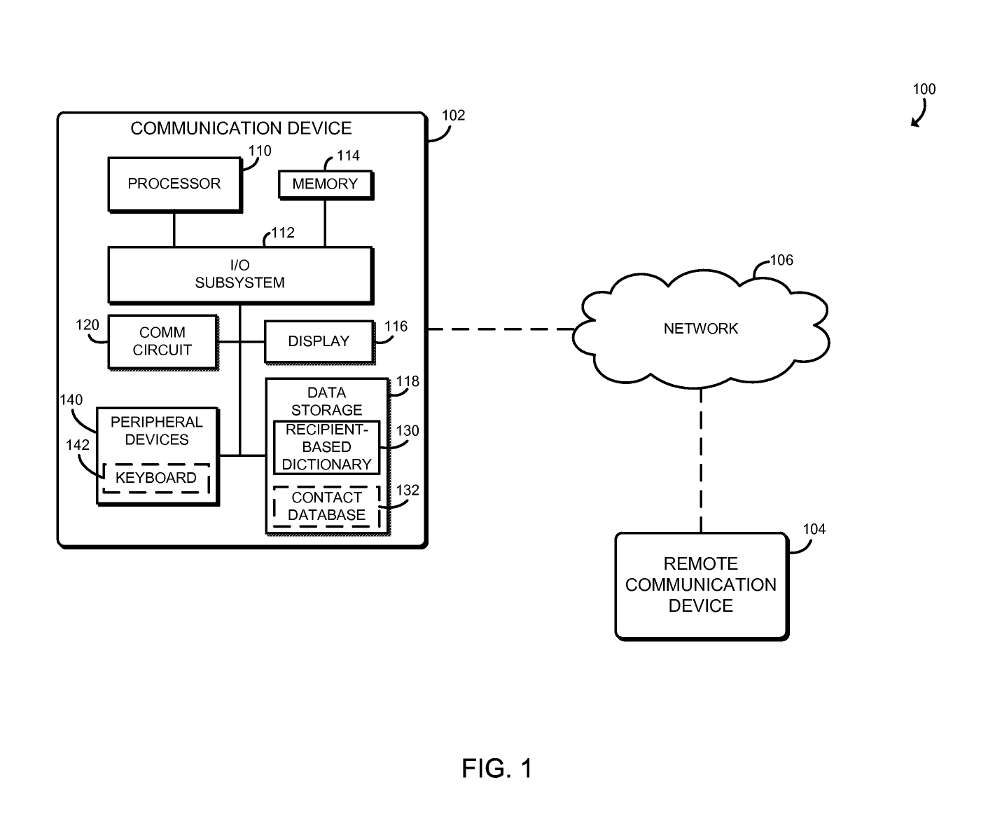

Referring now to FIG. 1, an illustrative system 100 for predictive texting includes a communication device 102 and one or more remote communication devices 104. In use, the communication device 102 is usable to communicate with a desired remote communication device 104 over a network 106 using a textual communication. The textual communication may include any type of text-based communication modality in which a user of the communication device 102 selects one or more textual characters to form a textual message. For example, the textual communication may include, but is not limited to, text messaging, instant messaging, e-mail, social networking, forum posting, short message service (SMS) messaging, and/or other text-based communication modalities. Of course, the communication devices 102, 104 may utilize non-textual communications, such as standard voice communications, in addition to the textual communications in some embodiments.

To facilitate the generation of the textual message, the communication device 102 is configured to provide recipient-based predictive texting assistance to the user. To do so, the communication device 102 presents one or more suggested textual phrases (e.g., single-word or multi-word phrases) to the user in response to the user's selection of one or more textual characters during the generation of the textual message. The user may select one of the suggested textual phrases to cause the suggested textual phrase to be added to the textual message without the need to manually enter the full textual phrase. However, unlike typical predictive texting, the suggested textual phrases, as well as the order of the suggested textual phrases, are determined based on the identity of the recipient (e.g., the identity of a user of a desired remote communication device 104). To do so, the communication device 102 is configured to determine the identity of the recipient and determine the suggested textual phrases based on the identity of the recipient and the user-selected textual character(s). As discussed in more detail below, the communication device 102 may determine the suggested textual phrases by comparing the identity of the recipient of the textual message and the user-selected textual character(s) to a recipient-based predictive text dictionary. As such, the user's selection of a particular textual character or string of characters may result in different suggested textual phrases for different recipients. For example, the user's selection of the letter “D” may result in a suggested textual phrase of “Dad” when the user is communicating with his/her father, but may result in a suggested textual phrase of “Dude” or “Duh” when the user is communicating with a friend.

The communication device 102 may be embodied as any type of communication device capable of facilitating communication with the remote communication device 104 and performing the functions described herein. For example, the communication device 102 may be embodied as a smartphone, a cellular phone, a tablet computer, a notebook computer, a laptop computer, a desktop computer, a distributed computing system, a multiprocessor system, a consumer electronic device, a smart appliance, and/or any other communication device capable of facilitating communications with the remote communication device 104. As shown in FIG. 1, the illustrative communication device 102 includes a processor 110, an I/O subsystem 112, memory 114, a display 116, a data storage 118, and a communication circuit 120. Of course, the communication device 102 may include other or additional components, such as those commonly found in a portable computer (e.g., various input/output devices), in other embodiments. Additionally, in some embodiments, one or more of the illustrative components may be incorporated in, or otherwise from a portion of, another component. For example, the memory 114, or portions thereof, may be incorporated in the processor 110 in some embodiments.

The processor 110 may be embodied as any type of processor capable of performing the functions described herein. For example, the processor may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the communication device 102 such as operating systems, applications, programs, libraries, and drivers. The memory 114 is communicatively coupled to the processor 110 via the I/O subsystem 112, which may be embodied as circuitry and/or components to facilitate input/output operations with the processor 110, the memory 114, and other components of the communication device 102. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 112 may form a portion of a system-on-a-chip (SoC) and be incorporated, along with the processor 110, the memory 114, and other components of the communication device 102, on a single integrated circuit chip.

The display 116 of the communication device 102 may be embodied as any type of display on which information may be visually presented to a user. The display 116 may be embodied as, or otherwise use, any suitable display technology including, for example, a liquid crystal display (LCD), a light emitting diode (LED) display, a cathode ray tube (CRT) display, a plasma display, and/or other display usable in a mobile computing device. In some embodiments, the display 116 may be embodied as a touchscreen display and include a corresponding touchscreen sensor (not shown) to receive tactile input and data entry from the user. In such embodiments, the touchscreen sensor may use any suitable touchscreen input technology to detect the user's tactile selection of information displayed on the touchscreen display 116 including, but not limited to, resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors.

The data storage 118 may be embodied as any type of device or devices configured for short-term or long-term storage of data such as, for example, memory devices and circuits, memory cards, hard disk drives, solid-state drives, or other data storage devices. The data storage device 118 may store various applications, program files, and other data used by the communication device 102. For example, in the illustrative embodiment, a recipient-based predictive text dictionary 130 is stored in the data storage 118. The recipient-based predictive text dictionary 130 stores suggested textual phrases in correlation with recipient identities and the user-selected textual character or characters. As such, the suggested textual phrase corresponding to a particular user-selected textual character or string of characters (e.g., “Bo”) may be different (e.g., “Bobby” or “Boss”) based on the recipient identity (e.g., “spouse” or “work colleague”, respectively). Additionally, in the illustrative embodiment, the suggested textual phrase(s) corresponding to a particular pair of user-selected textual character(s) and recipient identity is determined based on the frequency of use of the suggested textual phrase by the user during textual communications with the particular recipient. As such, the determined suggested textual phrase(s) corresponding a particular pair of user-selected textual character(s) and recipient identity may change over time.

The data storage 118 may also store a contact database 132 in some embodiments. The contact database 132 includes identity information for individuals or entities with whom the user of the communication device 102 typically converses. For example, the contact database 132 may include telephone numbers, e-mail addresses, and/or other identity information for each contact. The contact database 132 may be a stand-alone database, which is maintained by the communication device 102, or may form a portion of a communication software package such as an e-mail or cellphone application. Additionally, in some embodiments, the contact database 132 may identify one or more groups to which each contact belongs. For example, the contact database 132 may identify a contact named “Tom” as belonging to a group named “friend” and a group named “work colleague.” In some embodiments, the contact database 132, or a portion thereof, may be stored on a cloud server (not shown) with which the communication device 102 may communicate with over the network 106.

The communication circuitry 120 of the communication device 102 may be embodied as any communication circuit, device, or collection thereof, capable of enabling communications between the communication device 102 and the remote communication device 104 over the network 106. Depending on the particular type of communication modalities supported by the communication device 102, the communication circuitry 120 may be embodied as, or otherwise include, a cellular communication circuit, a data communication circuit, and/or other communication circuit technologies. As such, the communication circuit 120 may be configured to use any one or more suitable communication technology (e.g., wireless or wired communications) and associated protocols (e.g., GSM, CDMA, Ethernet, Bluetooth®, Wi-Fi®, WiMAX, etc.) to effect such communication.

The communication device 102 may also include one or more peripheral devices 140 in some embodiments. Such peripheral devices 140 may include any type of peripheral device commonly found in a typical communication device or computer device, such as various input/output devices. For example, the peripheral devices 140 may include a keyboard 142 to allow the user to enter data, such as textual characters, into the communication device 102. The keyboard 142 may be embodied as a virtual keyboard (e.g., a “soft” keyboard), a hardware keyboard, or a combination thereof.

The remote communication device 104 may be similar or dissimilar to the communication device 102. As such, the remote communication device 104 may be embodied as a smartphone, a cellular phone, a tablet computer, a notebook computer, a laptop computer, a desktop computer, a distributed computing system, a multiprocessor system, a consumer electronic device, a smart appliance, and/or any other communication device capable of facilitating communications with the communication device 102. The remote communication device 104 may include various components commonly found in a communication device or computer device, such as a processor, an I/O subsystem, memory, a communication circuit, a data storage, peripheral devices, and/or other or additional components (e.g., various input/output devices). The individual components of the remote communication device 104 may be similar to the corresponding components of the communication device 102, the description of which is applicable to the corresponding components of the remote communication device 104 and is not repeated herein so as not to obscure the present disclosure.

As discussed in more detail below, the communication device 102 and remote communication device 104 are configured to communicate with each other over the network 106. The network 106 may be embodied as any number of various wired and/or wireless voice and/or data networks. For example, the network 106 may be embodied as, or otherwise include, a cellular network, wired or wireless local area network (LAN), a wired or wireless wide area network (WAN), and/or a publicly-accessible, global network such as the Internet. As such, the network 106 may include any number of additional devices, such as additional computers, routers, and switches to facilitate communications among the devices of the system 100.

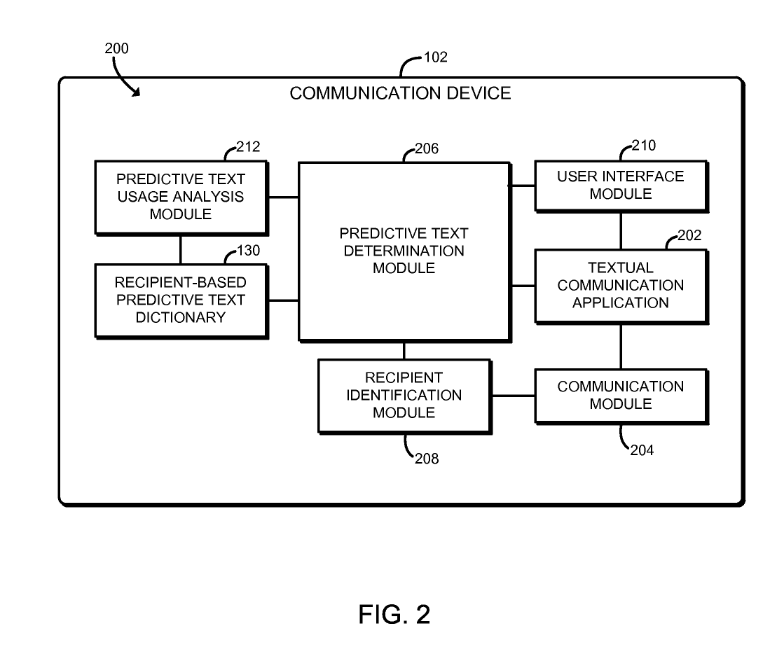

Referring now to FIG. 2, in the illustrative embodiment, the communication device 102 establishes an environment 200 during operation. The illustrative environment 200 includes one or more textual communication applications 202, a communication module 204, a predictive text determination module 206, a recipient identification module 208, a user interface module 210, a predictive text usage analysis module 212, and the recipient-based predictive text dictionary 130. Each of the modules 204, 206, 208, 210, and 212 may be embodied as hardware, firmware, software, or a combination thereof.

As discussed above, a user may operate the communication device 102 to communicate with a user of the remote communication device 104 over the network 106 using a textual communication. As such, one or more textual communication applications 202 may be executed on the communication device 102 to facilitate such textual communications via the communication module 204. For example, the textual communication applications 202 may include, but are not limited to, text messaging applications, instant messaging applications, e-mail applications, social networking applications, forum posting applications, short message service applications, and/or other text-based communication applications. During the formation of the textual messages of the various textual communications, the predictive text determination module 206 is configured to determine a suggested single- or multi-word textual phrase for the user of the communication device 102 based the user's selection of a textual character and the identity of a recipient of the textual message. To do so, the predictive text determination module 206 compares the textual character or string of characters selected by the user and the identity of the recipient of the textual communication to the recipient-based predictive text dictionary 130 to determine the suggested textual phrase and presents the textual phrase to the user via the user interface module 210.

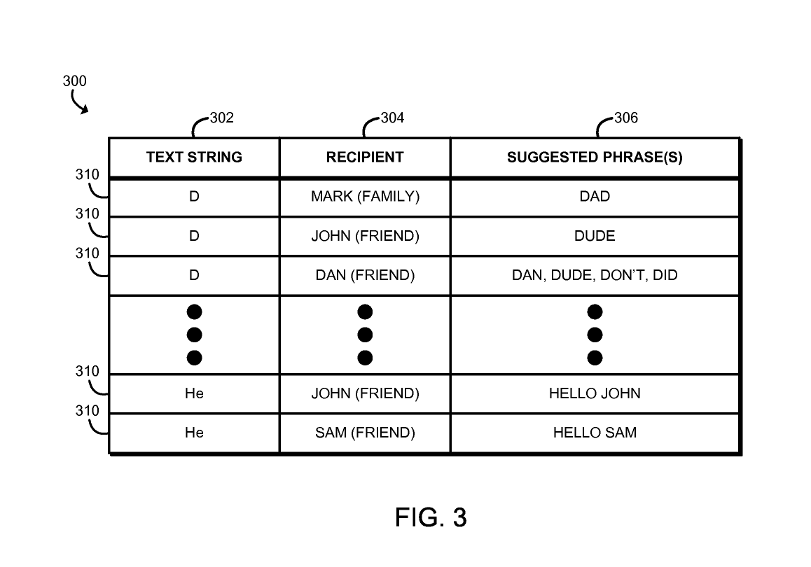

As discussed above, the recipient-based predictive text dictionary 130 stores suggested textual phrases in correlation with recipient identities and the user-selected textual character or characters based on a frequency of use of the suggested textual phrase in textual communications with the particular recipient. As such, the suggested textual phrase corresponding to a particular user-selected textual character(s) may be different based on the identity of the recipient. For example, an illustrative recipient-based predictive text dictionary 300 is shown in FIG. 3. The recipient-based predictive text dictionary 300 includes a text string column 302, a recipient column 304, and a suggested phrase(s) column 306. The text string column 302 includes various textual characters or string of textual characters 310, which may be used by the user during textual communications. For each identified textual character(s) 310, one or more recipients are identified in the recipient column 304. Additionally, for each pair of textual character(s) 310 and recipient, one or more suggested phrases are identified in the suggested phrase column 306. As such, the predictive text determination module 206 may determine a suggested textual phrase to assist the user during textual communications by comparing the user-selected character(s) and the identity of the recipient of the textual communication to the recipient-based predictive text dictionary 300.

For example, should the user select or enter the character “D” and the recipient is identified as “Mark” (who happens to be the user's father and, as such, may also be associated with a group named “Family), the predictive text determination module 206 would determine a suggested phrase of “Dad” and present that suggestion to the user via the user interface module 210. The user may then select the suggested phrase “Dad” to cause that phase to automatically be added into the textual message without the need for the user to fully type in the phrase “Dad.” Alternatively, if the recipient is identified as “John” (who happens to be a friend and, as such, may be associated with a group named “Friends”), the predictive text determination module 206 would determine a suggested phrase of “Dude.” Further, should the recipient be identified as “Dan,” the predictive text determination module 206 would determine several suggested phrases including “Dan,” “Dude,” “don't,” and “did,” which may be stored or ranked in order of frequency of use with the recipient “Dan” in the illustrative recipient-based predictive text dictionary 300. The predictive text determination module 206 may present those suggested phrases to the user in the ranked order of frequency of use (e.g., from left to right in descending frequency of use).

As discussed above, the suggested textual phrase stored in the recipient-based predictive text dictionary 130, 300 may embodied as single word phrases or multi-word phrases. For example, as shown in the illustrative recipient-based predictive text dictionary 300, should the user select or enter the character string “He” and the recipient is identified as “John,” the predictive text determination module 206 would determine a suggested phrase of “Hello John” and present that suggestion to the user via the user interface module 210. Alternatively, if the identified recipient is “Sam,” the predictive text determination module 206 would determine a suggested phrase of “Hello Sam.” In this way, the suggested textual phrases are customized to the particular recipient of the textual communication, which may increase the accuracy and usefulness of such suggestions.

Referring back to FIG. 2, the recipient identification module 208 is configured to identify the recipient of the textual communication. To do so, the recipient identification module 208 may utilize any methodology and data to identify the recipient for comparison to the recipient-based predictive text dictionary 130 as discussed above. For example, in some embodiments, the recipient identification module 208 may identify the recipient based on a cellular phone number, an Electronic Serial Number (ESN), a Mobile Equipment Identifier (MEID), an International Mobile Equipment Identity (IMEI), or other identification data associated with the remote communication device 104. In such embodiments, the recipient identification module 208 may compare the determined cellular phone number or other identification data to the contact database 132 to determine the identity of the recipient. In some embodiments, the recipient identification module 208 may communicate with the textual communication application 202 and/or a remote server to determine the identity of the recipient or identification information from which the identity can be determined (e.g., via comparison to the contacts database 132). Additionally, in some embodiments, the recipient identification module 208 may also determine a contacts group (e.g., “friends,” “family,” “work,” etc.) to which the recipient belongs. To do so, the recipient identification module 208 may compare the recipient identity to the contact database 132 to determine which groups, if any, to which the recipient belongs.

The predictive text usage analysis module 212 is configured to monitor the textual communications of the user of the communication device 102 and update the recipient-based predictive text dictionary 130 based on the user's textual usage. For example, the predictive text usage analysis module 212 may monitor which suggested textual phrases are selected by the user when communicating with a particular recipient and update the recipient-based predictive text dictionary 130 accordingly. As such, as the frequency of usage of a particular textual phrase increases over time, the textual phrase may be ranked higher such that the predictive text determination module 206 presents the particular textual phrase as a suggestion to the user. As discussed above, in some embodiments, multiple suggested textual phrases may be presented to the user and arranged in order of their corresponding frequency of use by the user when communicating with a particular recipient.

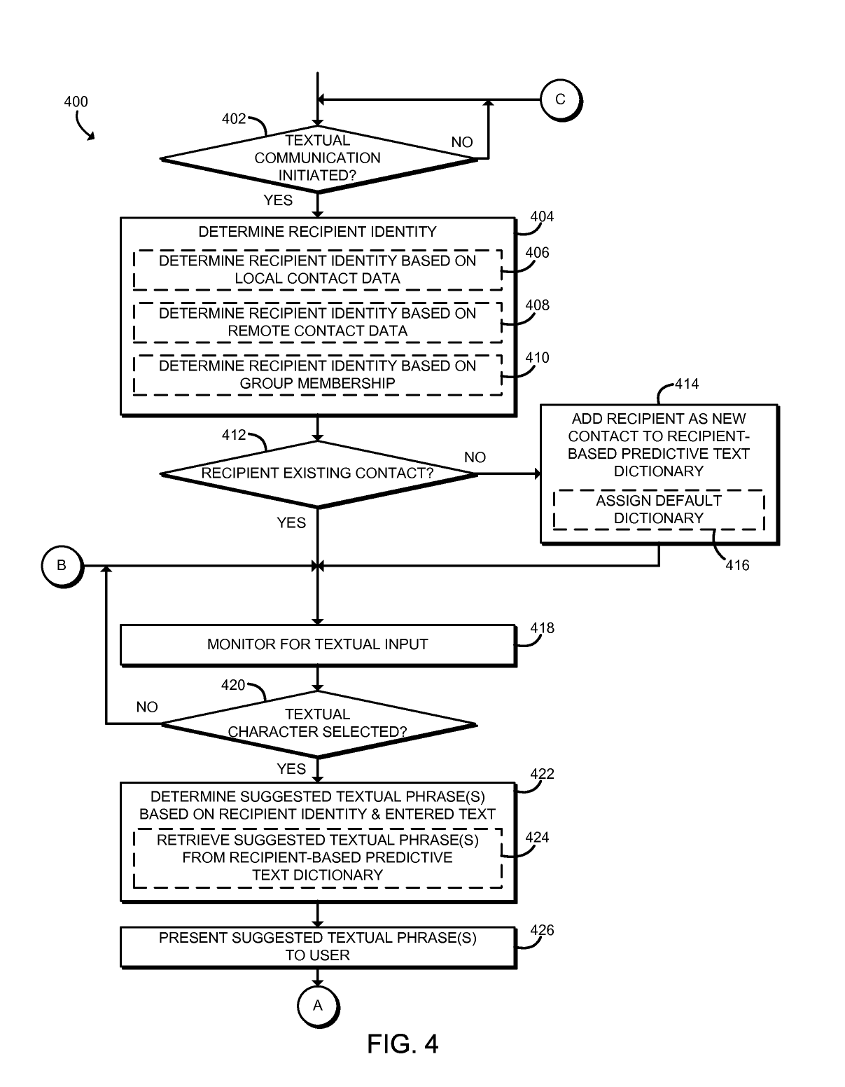

Referring now to FIGS. 4 and 5, in use, the communication device 102 may execute a method 400 for predictive texting based on an identity of a recipient. The method 400 begins with block 402 in which the communication device 102 determines whether the user has initiated a textual communication. To do so, the communication device 102 may monitor, for example, the activity of one or more of the textual communication applications for initiation of a textual message. The textual message may be, for example, an original textual message to a desired recipient or a textual message in response to receiving a prior textual message from the user of the remote communication device 104. If no textual communication has been initiated, the method 400 loops back to block 402 in which the communication device 102 continues to monitor for initiation of a textual message by the user.

However, if the communication device 102 determines that the user has initiated a textual communication, the method 400 advances to block 404. In block 404, the communication device 102 determines the identity of the recipient or recipients of the textual communication. As discussed above, the communication device 102 may employ any one or more methodologies for determining the identity of the recipient. For example, in block 406, the communication device 102 may access the local contact database 132 to determine the identity of the recipient. In some embodiments, as discussed above, the communication device 102 may compare the cellular telephone number or other identity data (e.g., contact nick-name) of the recipient (or unknown received message) to the contact database 132 to determine the identity of the recipient. Additionally or alternatively, the communication device 102 may access remote contact data stored on a remote server to determine the identity of the recipient in block 408. For example, as discussed above, a portion of the contact database 132 may be stored on a remote server and accessed by the communication device 102 to determine the identity of the recipient of the textual communication (e.g., by comparing the cellular telephone number of the recipient). Additionally, in some embodiments, the communication device 102 may be configured to access other remote servers, such as social networking sites, to retrieve data useful in identifying the recipient. Additionally, in some embodiments, the communication device 102 may also determine a pre-defined group (e.g., “family,” “friend,” “work,” etc.) to which the recipient belongs in block 410. To do so, the communication device 102 may compare the identity of the recipient to the local contact database 132 or a remote contact database to determine which, if any, groups the recipient belongs.

After the recipient has been identified in block 404, the communication device 102 determines whether the recipient is an existing contact in block 412. To do so, the communication device 102 may analyze the recipient-based predictive text dictionary 130 to determine whether the recipient is included as a recognized contact in the dictionary 130. If not, the method 400 advances to block 414 in which the identified recipient is added as a new contact to the recipient-based predictive text dictionary 130. Additionally, because the current recipient is a new contact, the communication device 102 may assign the recipient a default recipient-based predictive text dictionary in block 416 in some embodiments. The default recipient-based predictive text dictionary may include default, pre-defined suggested textual phrases for user-selected text strings when the user is communicating with the current recipient.

After the recipient has been added as a new contact to the recipient-based predictive text dictionary 130 or if the recipient is determined to be an existing contact in block 412, the method 400 advances to block 418. In block 418, the communication device 102 monitors for textual input. To do so, the communication device 102 may monitor the virtual or physical keyboard 142 for selection of a character or string of characters by the user. For example, as the user of the communication device 102 is typing a textual message, the communication device 102 may monitor the textual characters selected by the user. The communication device 102 determines whether a textual character has been selected by the user in block 420. If not, the method loops back to block 418 in which the communication device 102 continues to monitor for textual input by the user. If, however, the user has selected a textual character, the method 400 advances to block 422.

In block 422, the communication device 102 determines a suggested textual phrase or phrases based on the identity of the recipient and the character or string of characters selected by the user. To do so, the communication device 102 may compare the data pair of (i) the recipient identity and (ii) the selected character(s) to the recipient-based predictive text dictionary 130 in block 424. As discussed above, the recipient-based predictive text dictionary 130 stores suggested textual phrases in correlation with recipient identities and user-selected textual character strings based on a frequency of use of the suggested textual phrase while communicating with the particular recipient. The suggested textual phrase may be embodied as a single-word or multi-word phrase. Additionally, as explained above, the recipient-based predictive text dictionary 130 may store more than one suggested textual phrase for a particular data pair of recipient identity and user-selected textual character string. As such, the communication device 102 may retrieve multiple suggested textual phrases, in order of frequency of use by the user with the current identified recipient, in block 424.

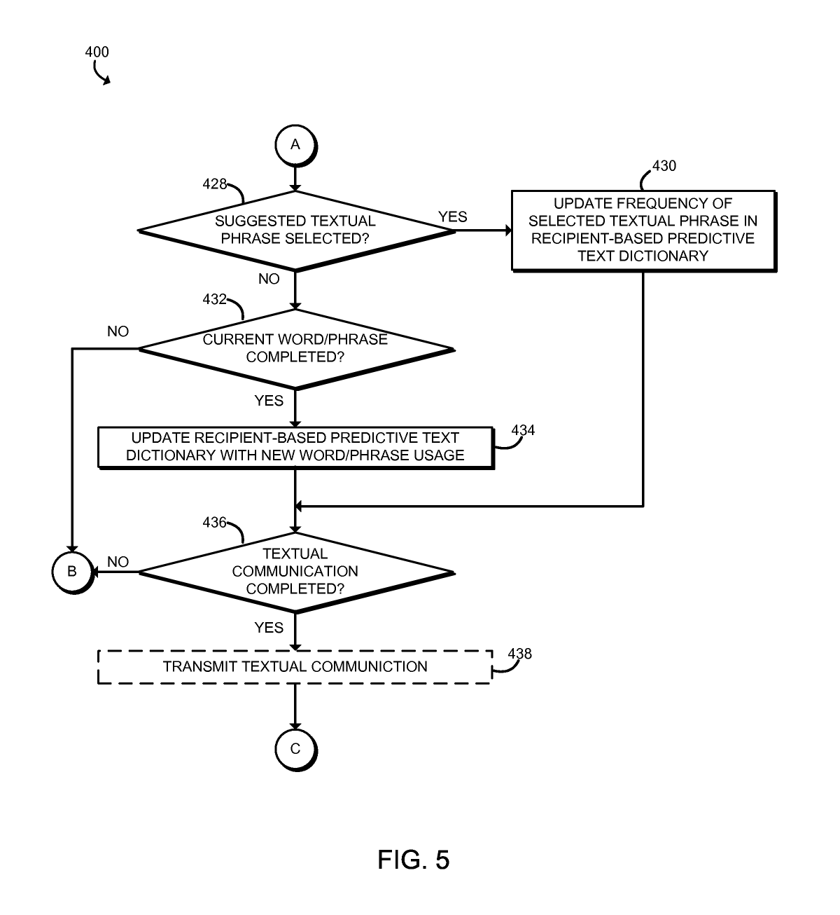

After the suggested textual phrase(s) has been retrieved in block 422, the phrase(s) is presented to the user in block 426. For example, the suggested textual phrase(s) may be displayed to the user via the display 116, presented to the user in audible form via a speaker, or presented in some other manner that allows a user to select one of the suggested textual phrases if so desired. Again, it should be appreciated that the particular suggested textual phrase, and/or order of the suggested textual phrases, presented to the user may differ for different identified recipients even though the user has selected the same textual character string. For example, an illustrative user interface 600 displayed on the display 116 of the communication device 102 is shown in FIG. 6. In the illustrative example, the user of the communication device 102 is textually communicating with the user's father using an instant messaging application. The user selects or otherwise enters a textual character 602 (“D”) while constructing a textual message 604. In response, the communication device 102 determines a suggested textual phrase 606 (“Dad”) based on the identity of the recipient of the textual communication (i.e., the user's father) and the selected textual character 602 and presents the suggested textual phrase 606 to the user. The user of the communication device 102 may select the suggested textual phrase 606 to cause the selected phrase to be automatically added to the textual message 604. Of course, although only one suggested textual phrase 606 is shown in the illustrative example of FIG. 6, it should be appreciated that the communication device 102 may determine multiple suggested textual phrases and present them to the user in order of frequency of use with the identified recipient (i.e., the user's father in the illustrative example).

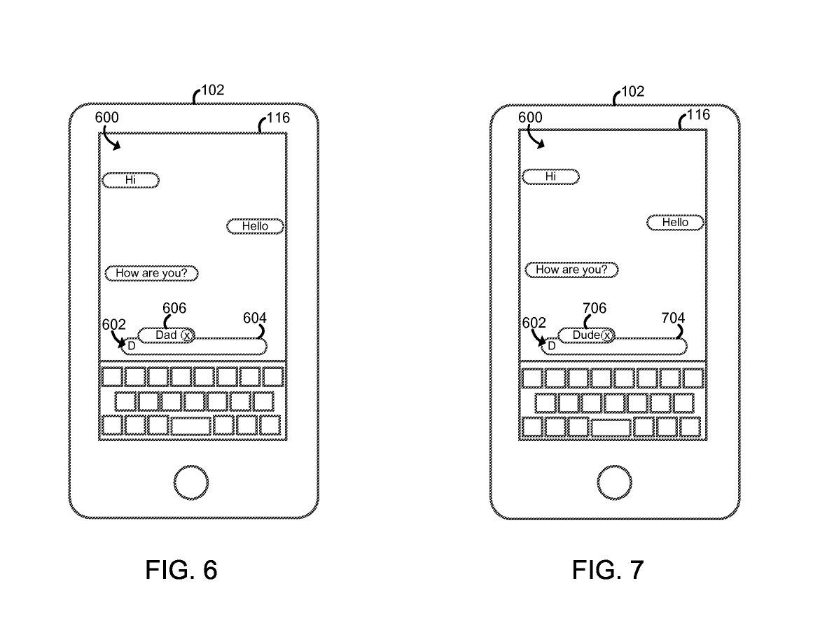

Alternatively, in the illustrative example shown in FIG. 7, the user of the communication device 102 is textually communicating with a friend. The user again selects or otherwise enters the textual character 602 (“D”) while constructing a textual message 704. In response, the communication device 102 determines a suggested textual phrase 706 (“Dude”) based on the identity of the recipient of the textual communication (i.e., the user's friend) and the selected textual character 602 and presents the suggested textual phrase 706 to the user. It should be appreciated that the suggested textual phrase 706 is different from the suggested textual phrase 606, even though the user has selected the same textual character 602. In this way, the communication device 102 customizes the suggested textual phrase based on the identity of the recipient of the textual communication.

Referring back to block 426 of FIG. 4, after the communication device 102 has presented the suggested textual phrase(s) to the user, the method 400 advances to block 428 of FIG. 5. In block 428, the communication device 102 determines whether the user has selected one of the presented suggested textual phrases. The user may select a suggested textual phrase by tapping on the display 116 in those embodiments in which the display 116 is embodied as a touchscreen display, by selecting the desired suggested textual phrase using the keyboard 142, and/or in any other suitable manner. If the user selects a suggested textual phrase, the method 400 advances to block 430 in which the communication device 102 updates the frequency of use of the selected suggested textual phrase in the recipient-based predictive text dictionary 130. In this way, the communication device 102 may improve the accuracy of the suggested textual phrases over time based on the user's usage of the textual phrases with a particular recipient. As discussed above, the ranking or order of presentation of suggested textual phrases may be based on their frequency of use, which may be updated or changed over time in block 430.

After the recipient-based predictive text dictionary 130 is updated in block 430, the method 400 advances to block 436 in which the communication device 102 determines whether the textual communication (e.g., the current textual message) is completed. If not, the method 400 loops back to block 418 in which the communication device 102 continues to monitor for additional textual input (e.g., selection of another textual character). However, if the textual communication is completed, the communication device 102 may transmit the textual communication to the remote communication device 104 in block 438 in some embodiments. Regardless, after the textual communication is completed, the method 400 loops back to block 402 in which the communication device 102 determines whether a new textual communication (e.g., a new textual message) is initiated as discussed above.

Referring back to block 428, if the user does not select a presented suggested textual phrase, the method 400 advances to block 432. In block 432, the communication device 102 determines whether the current word or phrase is completed. To do so, the communication device 102 may utilize any suitable methodology for determining that the user has completed a word or phrase including, but not limited to, monitoring for special characters (e.g., a space or period), identifying completed words or phrases, and/or the like. If the communication device 102 determines that the current word or phrase is not completed, the method 400 loops back to block 418 in which the communication device 102 continues to monitor for additional textual input (e.g., selection of another textual character). However, if the communication device 102 determines that the current word or phrase is completed, the method 400 advances to block 434. In block 434, the communication device 102 determines that the user has used a new word or phrase and updates the recipient-based predictive text dictionary 130 with the new word or phrase. As discussed above, the communication device 102 may subsequently update the frequency of use of the new word or phrase as the user uses the word/phrase in communication with the particular recipient (see block 430).

After the new word or phrase has been added to the recipient-based predictive text dictionary 130 in block 434, the method 400 advances to block 436. As discussed above, the communication device 102 determines whether the textual communication is completed in block 436. If not, the method 400 loops back to block 418 in which the communication device 102 continues to monitor for additional textual input. However, if the textual communication is completed, the communication device 102 advances to block 438 in which the textual communication may be transmitted to the remote communication device 104 as discussed above.

### EXAMPLES

Illustrative examples of the devices, systems, and methods disclosed herein are provided below. An embodiment of the devices, systems, and methods may include any one or more, and any combination of, the examples described below.

Example 1 includes a communication device for predictive texting. The communication device may include a recipient identification module to determine an identity of a recipient of a textual communication from the communication device; a predictive text determination module to receive a selection of a textual character from a user and determine a suggested textual phrase based on the selected textual character and the identity of the recipient; and a user interface module to present the suggested textual phrase to the user.

Example 2 includes the subject matter of Example 1, and further including a contact database to store contact information for a plurality of recipients, and wherein the recipient identification module is to access the contact database to determine the identity of the recipient.

Example 3 includes the subject matter of any of Examples 1 and 2, and wherein to determine the identity of the recipient comprises to retrieve information indicative of the identity of the recipient from a remote server.

Example 4 includes the subject matter of any of Examples 1-3, and wherein to determine the identity of the recipient comprises to identify a pre-established group of contacts to which the recipient belongs.

Example 5 includes the subject matter of any of Examples 1-4, and further including g a recipient-based predictive text dictionary stored on the communication device, and wherein the predictive text determination module is to determine whether a contact entry for the identified exists in the recipient-based predictive text dictionary.

Example 6 includes the subject matter of any of Examples 1-5, and wherein the predictive text determination module is to establish a new contact entry in the recipient-based predictive text dictionary for the identified recipient in response to a determination that a contact entry for the identified recipient does not exist in the recipient-based predictive text dictionary.

Example 7 includes the subject matter of any of Examples 1-6, and wherein the predictive text determination module is to load a default predictive text dictionary in response to a determination that a contact entry for the identified recipient does not exist in the recipient-based predictive text dictionary.

Example 8 includes the subject matter of any of Examples 1-7, and wherein to receive the selection of the textual character comprises to receive a selection, by the user, of a textual character of a physical or virtual keyboard of the communication device.

Example 9 includes the subject matter of any of Examples 1-8, and wherein to receive the selection of the textual character comprises to receive a selection, by the user, of an alphanumerical character of the physical or virtual keyboard.

Example 10 includes the subject matter of any of Examples 1-9, and wherein the suggested textual phrase comprises a suggested textual word.

Example 11 includes the subject matter of any of Examples 1-10, and wherein the suggested textual phrase comprises a suggested textual multi-word phrase.

Example 12 includes the subject matter of any of Examples 1-11, and wherein the predictive text determination module is to determine the suggested textual phrase based on a plurality of textual characters consecutively selected by the user.

Example 13 includes the subject matter of any of Examples 1-12, and wherein the predictive text determination module is to determine a plurality of suggested textual words based on the selected textual character and the recipient identity, and the user interface module is to present the plurality of suggested textual words to the user in a list based on a historical frequency of use of each suggested textual word by the user during textual communications with the identified recipient.

Example 14 includes the subject matter of any of Examples 1-13, and further including a recipient-based predictive text dictionary stored on the communication device, and wherein the predictive text determination module is to compare the identity of the recipient and the selected textual character to the recipient-based predictive text dictionary stored on the communication device to determine the suggested textual phrase.

Example 15 includes the subject matter of any of Examples 1-14, and wherein the recipient-based predictive text dictionary correlates the pair of (i) the identity of the recipient and (ii) the selected textual character to one or more suggested textual phrases based on a historical frequency of use of each suggested textual phrase by the user during textual communications with the identified recipient.

Example 16 includes the subject matter of any of Examples 1-15, and further including a predictive text usage analysis module to (i) determine whether the suggested textual phrase is selected by the user and (ii) update the recipient-based predictive text dictionary based on the user's selection of the suggested textual phrase.

Example 17 includes the subject matter of any of Examples 1-16, and wherein to update the recipient-based predictive text dictionary comprises to update a frequency of use of the selected textual phrase by the user based on the identity of the recipient.

Example 18 includes the subject matter of any of Examples 1-17, and further including a predictive text usage analysis module to (i) determine whether the suggested textual phrase is selected by the user and (ii) update the recipient-based predictive text dictionary to include a new textual word entered by the user in response to determining no suggested textual phrase was selected by the user.

Example 19 includes the subject matter of any of Examples 1-18, and wherein the recipient identification module is to (i) determine an identity of a first recipient of a first textual communication and (ii) determine an identity of a second recipient of a second textual communication, and the predictive text determination module is to (i) determine a first suggested textual phrase based on the selected textual character and the identity of the first recipient and (ii) determine a second suggested textual phrase based on the selected textual character and the identity of the second recipient, wherein the second suggested textual phrase is different from the first textual phrase.

Example 20 includes a method for predictive texting. The method includes determining, by a communication device, an identity of a recipient of a textual communication; receiving, by the communication device, a selection of a textual character from a user; determining a suggested textual phrase based on the selected textual character and the identity of the recipient; and presenting, by the communication device, the suggested textual phrase to the user.

Example 21 includes the subject matter of Example 20, and wherein determining the identity of the recipient of the textual communication comprises determining the identity of the recipient based on a contact database stored on the communication device.

Example 22 includes the subject matter of any of Examples 20 and 21, and wherein determining the identity of the recipient of the textual communication comprises retrieving information indicative of the identity of the recipient from a remote server.

Example 23 includes the subject matter of any of Examples 20-22, and wherein determining the identity of the recipient of the textual communication comprises identifying a pre-established group of contacts to which the recipient belongs.

Example 24 includes the subject matter of any of Examples 20-23, and further including determining whether a contact entry for the identified recipient exists in a recipient-based predictive text dictionary stored on the communication device.

Example 25 includes the subject matter of any of Examples 20-24, and further including establishing a new contact entry in the recipient-based predictive text dictionary for the identified recipient in response to determining a contact entry for the identified recipient does not exist in the recipient-based predictive text dictionary.

Example 26 includes the subject matter of any of Examples 20-25, and further including loading a default predictive text dictionary in response to determining a contact entry for the identified recipient does not exist in the recipient-based predictive text dictionary.

Example 27 includes the subject matter of any of Examples 20-26, and wherein receiving the selection of the textual character comprises receiving a selection, by the user, of a textual character of a physical or virtual keyboard of the communication device.

Example 28 includes the subject matter of any of Examples 20-27, and wherein receiving the selection of the textual character comprises receiving a selection, by the user, of an alphanumerical character of the physical or virtual keyboard.

Example 29 includes the subject matter of any of Examples 20-28, and wherein determining the suggested textual phrase comprises determining a suggested textual word based on the selected textual character and the recipient identity.

Example 30 includes the subject matter of any of Examples 20-29, and wherein determining the suggested textual phrase comprises determining a suggested textual multi-word phrase based on the selected textual character and the recipient identity.

Example 31 includes the subject matter of any of Examples 20-30, and wherein determining the suggested textual phrase comprises determining a suggested textual phrase based on a plurality of textual characters consecutively selected by the user.

Example 32 includes the subject matter of any of Examples 20-31, and wherein determining the suggested textual phrase comprises determining a plurality of suggested textual words based on the selected textual character and the recipient identity, and wherein presenting the suggested textual phrase comprises presenting the plurality of suggested textual words in a list based on a historical frequency of use of each suggested textual word by the user during textual communications with the identified recipient.

Example 33 includes the subject matter of any of Examples 20-32, and wherein determining the suggested textual phrase comprises comparing the identity of the recipient and the selected textual character to a recipient-based predictive text dictionary stored on the communication device.

Example 34 includes the subject matter of any of Examples 20-33, and wherein the recipient-based predictive text dictionary correlates the pair of (i) the identity of the recipient and (ii) the selected textual character to one or more suggested textual phrases based on a historical frequency of use of each suggested textual phrase by the user during textual communications with the identified recipient.

Example 35 includes the subject matter of any of Examples 20-34, and further including determining whether the suggested textual phrase is selected by the user; and updating the recipient-based predictive text dictionary based on the user's selection of the suggested textual phrase.

Example 36 includes the subject matter of any of Examples 20-35, and wherein updating the recipient-based predictive text dictionary comprises updating a frequency of use of the selected textual phrase by the user based on the identity of the recipient.

Example 37 includes the subject matter of any of Examples 20-36, and further including determining whether the suggested textual phrase is selected by the user; and updating the recipient-based predictive text dictionary to include a new textual word entered by the user in response to determining no suggested textual phrase was selected by the user.

Example 38 includes the subject matter of any of Examples 20-37, and wherein (i) determining the identity of the recipient comprises determining an identity of a first recipient of a first textual communication and (ii) determining the suggested textual phrase comprises determining a first suggested textual phrase based on the selected textual character and the identity of the first recipient; and further comprising determining the identity of a second recipient of a second textual communication; and determining a second suggested textual phrase based on the selected textual character and the identity of the second recipient, wherein the second suggested textual phrase is different from the first textual phrase.

Example 39 includes a communication device comprising a processor; and a memory having stored therein a plurality of instructions that when executed by the processor cause the computing device to perform the method of any of Examples 20-38.

Example 40 includes one or more machine-readable storage media comprising a plurality of instructions stored thereon that in response to being executed result in a communication device performing the method of any of Examples 20-38.

Example 41 includes a communication device comprising means for performing the method of any of Examples 20-38.

1. A communication device for predictive texting, the communication device comprising:
a recipient identification module to determine an identity of a recipient of a textual communication from the communication device;
a predictive text determination module to receive a selection of a textual character from a user and determine a suggested textual phrase based on the selected textual character and the identity of the recipient; and
a user interface module to present the suggested textual phrase to the user.

2. The communication device of claim 1, further comprising a recipient-based predictive text dictionary stored on the communication device, and
wherein the predictive text determination module is to determine whether a contact entry for the identified exists in the recipient-based predictive text dictionary.

3. The communication device of claim 2, wherein the predictive text determination module is to establish a new contact entry in the recipient-based predictive text dictionary for the identified recipient in response to a determination that a contact entry for the identified recipient does not exist in the recipient-based predictive text dictionary.

4. The communication device of claim 3, wherein the predictive text determination module is to load a default predictive text dictionary in response to a determination that a contact entry for the identified recipient does not exist in the recipient-based predictive text dictionary.

5. The communication device of claim 1, wherein the predictive text determination module is to determine a plurality of suggested textual words based on the selected textual character and the recipient identity, and
the user interface module is to present the plurality of suggested textual words to the user in a list based on a historical frequency of use of each suggested textual word by the user during textual communications with the identified recipient.

6. The communication device of claim 1, further comprising a recipient-based predictive text dictionary stored on the communication device, and
wherein the predictive text determination module is to compare the identity of the recipient and the selected textual character to the recipient-based predictive text dictionary stored on the communication device to determine the suggested textual phrase.

7. The communication device of claim 6, wherein the recipient-based predictive text dictionary correlates the pair of (i) the identity of the recipient and (ii) the selected textual character to one or more suggested textual phrases based on a historical frequency of use of each suggested textual phrase by the user during textual communications with the identified recipient.

8. The communication device of claim 6, further comprising a predictive text usage analysis module to (i) determine whether the suggested textual phrase is selected by the user and (ii) update the recipient-based predictive text dictionary based on the user's selection of the suggested textual phrase, wherein to update the recipient-based predictive text dictionary comprises to update a frequency of use of the selected textual phrase by the user based on the identity of the recipient.

9. The communication device of claim 1, wherein:
the recipient identification module is to (i) determine an identity of a first recipient of a first textual communication and (ii) determine an identity of a second recipient of a second textual communication, and
the predictive text determination module is to (i) determine a first suggested textual phrase based on the selected textual character and the identity of the first recipient and (ii) determine a second suggested textual phrase based on the selected textual character and the identity of the second recipient, wherein the second suggested textual phrase is different from the first textual phrase.

10. One or more machine-readable storage media comprising a plurality of instructions stored thereon that, in response to being executed, cause a communication device to:
determine an identity of a recipient of a textual communication;
receive a selection of a textual character from a user;
determine a suggested textual phrase based on the selected textual character and the identity of the recipient; and
present the suggested textual phrase to the user.

11. The one or more machine-readable storage media of claim 10, wherein the plurality of instructions further cause the communication device to determine whether a contact entry for the identified recipient exists in a recipient-based predictive text dictionary stored on the communication device.

12. The one or more machine-readable storage media of claim 11, wherein the plurality of instructions further cause the communication device to establish a new contact entry in the recipient-based predictive text dictionary for the identified recipient in response to a determination that a contact entry for the identified recipient does not exist in the recipient-based predictive text dictionary.

13. The one or more machine-readable storage media of claim 12, wherein the plurality of instructions further cause the communication device to load a default predictive text dictionary in response to a determination that a contact entry for the identified recipient does not exist in the recipient-based predictive text dictionary.

14. The one or more machine-readable storage media of claim 13, wherein to determine the suggested textual phrase comprises to determine a plurality of suggested textual words based on the selected textual character and the recipient identity, and
wherein to present the suggested textual phrase comprises to present the plurality of suggested textual words in a list based on a historical frequency of use of each suggested textual word by the user during textual communications with the identified recipient.

15. The one or more machine-readable storage of claim 10, wherein to determine the suggested textual phrase comprises to compare the identity of the recipient and the selected textual character to a recipient-based predictive text dictionary stored on the communication device, wherein the recipient-based predictive text dictionary correlates the pair of (i) the identity of the recipient and (ii) the selected textual character to one or more suggested textual phrases based on a historical frequency of use of each suggested textual phrase by the user during textual communications with the identified recipient.

16. The one or more machine-readable storage of claim 10, wherein to determine the suggested textual phrase comprises to compare the identity of the recipient and the selected textual character to a recipient-based predictive text dictionary stored on the communication device, and wherein the plurality of instructions further cause the communication device to:
determine whether the suggested textual phrase is selected by the user; and
update a frequency of use of the selected textual phrase in the recipient-based predictive text dictionary based on the user's selection of the suggested textual phrase and the identity of the recipient.

17. The one or more machine-readable storage of claim 10, wherein to determine the suggested textual phrase comprises to compare the identity of the recipient and the selected textual character to a recipient-based predictive text dictionary stored on the communication device, and further comprising:
determine whether the suggested textual phrase is selected by the user; and
update the recipient-based predictive text dictionary to include a new textual word entered by the user in response to determining no suggested textual phrase was selected by the user.

18. The one or more machine-readable storage of claim 10, wherein (i) to determine the identity of the recipient comprises to determine an identity of a first recipient of a first textual communication and (ii) to determine the suggested textual phrase comprises to determine a first suggested textual phrase based on the selected textual character and the identity of the first recipient; and wherein the plurality of instructions further cause the communication device to:
determine the identity of a second recipient of a second textual communication; and
determine a second suggested textual phrase based on the selected textual character and the identity of the second recipient, wherein the second suggested textual phrase is different from the first textual phrase.

19. A method for predictive texting, the method comprising:
determining, by a communication device, an identity of a recipient of a textual communication;
receiving, by the communication device, a selection of a textual character from a user;
determining a suggested textual phrase based on the selected textual character and the identity of the recipient; and
presenting, by the communication device, the suggested textual phrase to the user.

20. The method of claim 19, further comprising determining whether a contact entry for the identified recipient exists in a recipient-based predictive text dictionary stored on the communication device.

21. The method of claim 20, further comprising establishing a new contact entry in the recipient-based predictive text dictionary for the identified recipient in response to determining a contact entry for the identified recipient does not exist in the recipient-based predictive text dictionary.

22. The method of claim 19, wherein determining the suggested textual phrase comprises determining a plurality of suggested textual words based on the selected textual character and the recipient identity, and
wherein presenting the suggested textual phrase comprises presenting the plurality of suggested textual words in a list based on a historical frequency of use of each suggested textual word by the user during textual communications with the identified recipient.

23. The method of claim 19, wherein determining the suggested textual phrase comprises comparing the identity of the recipient and the selected textual character to a recipient-based predictive text dictionary stored on the communication device, wherein the recipient-based predictive text dictionary correlates the pair of (i) the identity of the recipient and (ii) the selected textual character to one or more suggested textual phrases based on a historical frequency of use of each suggested textual phrase by the user during textual communications with the identified recipient.

24. The method of claim 19, wherein determining the suggested textual phrase comprises comparing the identity of the recipient and the selected textual character to a recipient-based predictive text dictionary stored on the communication device, and further comprising:
determining whether the suggested textual phrase is selected by the user; and
updating a frequency of use of the selected textual phrase in the recipient-based predictive text dictionary based on the user's selection of the suggested textual phrase and the identity of the recipient.

25. The method of claim 19, wherein (i) determining the identity of the recipient comprises determining an identity of a first recipient of a first textual communication and (ii) determining the suggested textual phrase comprises determining a first suggested textual phrase based on the selected textual character and the identity of the first recipient; and further comprising:
determining the identity of a second recipient of a second textual communication; and
determining a second suggested textual phrase based on the selected textual character and the identity of the second recipient, wherein the second suggested textual phrase is different from the first textual phrase.
